(19) United States
(12) Patent Application Publication
(10) Pub. No.: US 2024/0121569 A1
(43) Pub. Date: Apr. 11, 2024

(54) ALTERING AUDIO AND/OR PROVIDING NON-AUDIO CUES ACCORDING TO LISTENER'S AUDIO DEPTH PERCEPTION

(71) Applicant: Sony Interactive Entertainment Inc., Tokyo (JP)

(72) Inventors: Mahdi Azmandian, San Mateo, CA (US); Victoria Dorn, San Mateo, CA (US)

(21) Appl. No.: 18/045,169

(22) Filed: Oct. 9, 2022

(51) Int. Cl. H04S 7/00; A63F 13/54

(52) U.S. Cl. CPC H04S 7/302; A63F 13/54

(57) ABSTRACT

The 3D audio perception of a listener such as a computer gamer is tested “stereoscopically” and the results input to a source of audio such as a computer game. Audio from the source of audio (such as a head-mounted display of a computer game system or speaker outputting audio from a game console) may be altered to account for the listener's measured 3D audio acuity. In addition, or alternatively, visual or haptic cues may be provided to alert the listener of 3D audio events.

### FIELD

The present application relates generally to altering audio and/or providing non-audio cues according to a listener's audio depth perception.

### BACKGROUND

As understood herein, people can experience varying degrees of audio directionality perception due to various causes. In the context of presenting computer simulations such as computer games, this means that a person might not accurately perceive the virtual location of an audio object as intended by the game developer, potentially causing confusion or loss of enjoyment on the part of the person playing the simulation.

### SUMMARY

Accordingly, an apparatus includes at least one processor configured to identify a directional deviation in hearing of a person. The processor also is configured to alter a demanded virtual location of at least one audio object according to the directional deviation to render a modified location, and present the audio object at the modified location, e.g., using at least one virtual or physical speaker.

In some example embodiments, the processor is configured to identify the directional deviation based at least in part on an audio directionality profile of the person in both the horizontal and vertical dimensions. The audio directionality profile may include directional deviations at respective locations. A first one of the directional deviations can have a different direction than a second one of the directional deviations. The respective locations may include locations in space around the head of the person.

One example way of representation a directional deviation is a vector.

In non-limiting implementations, the directional deviation is a first directional deviation associated with a first location and the processor can be configured to identify a second directional deviation in hearing of the person. The second directional deviation is associated with a second location, and the demanded virtual location in this example is between the first and second locations. The instructions can be executable to render the modified location of the audio object at least in part by interpolating between the first and second directional deviations.

In non-limiting embodiments the processor can be configured to present at least one visual cue of a location of the audio object and/or to present at least one tactile cue of a location of the audio object.

In another aspect, a method includes identifying a location for at last one audio object in a computer simulation, and presenting at least one visual cue of the location and/or presenting at least one tactile cue of the location.

In another aspect, a device includes at least one computer storage that is not a transitory signal and that in turn includes instructions executable by at least one processor to identify a demanded virtual location for an audio object in a computer simulation. The instructions also are executable to access an audio directionality profile for a player of the computer simulation. The audio directionality profile includes at last one offset or deviation in hearing directionality, and the instructions are executable to alter the demanded virtual location according to the offset or deviation.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example specific system consistent with present principles;

FIG. 3 illustrates an example data flow architecture consistent with present principles;

FIG. 4 illustrates a first example system for establishing the audio directionality profile of a person;

FIG. 5 illustrates a second example system for establishing the audio directionality profile of a person;

FIG. 6 graphically illustrates a person's audio directionality;

FIG. 7 illustrates a person's audio directionality in table form;

FIG. 8 illustrates example logic in example flow chart format for shifting the virtual locations of audio objects according to a person's audio directionality profile;

FIG. 9 is a screen shot of an example user interface for providing visual feedback to a person with audio directionality deviations; and

FIG. 10 is illustrates example logic in example flow chart format for providing haptic feedback to a person with audio directionality deviations.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

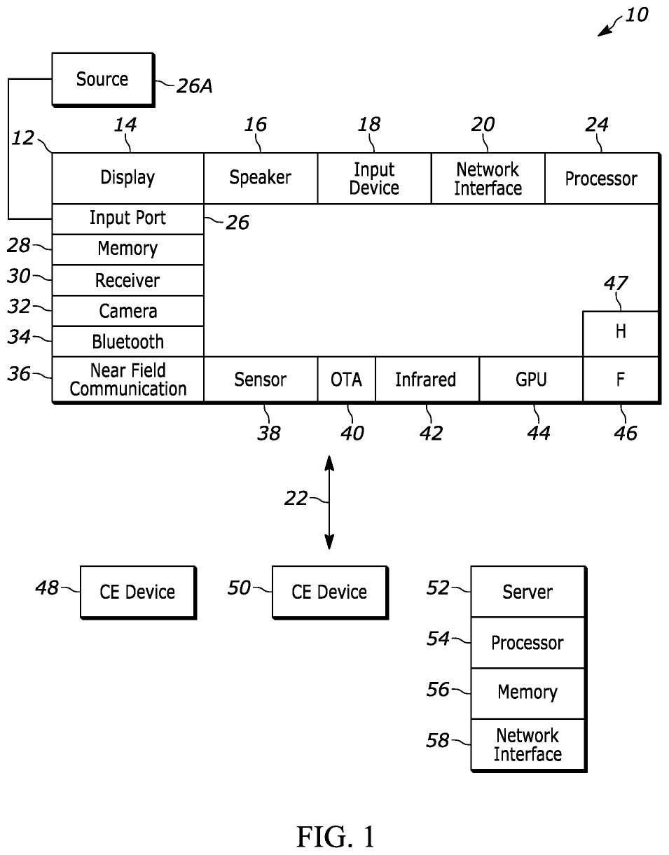

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

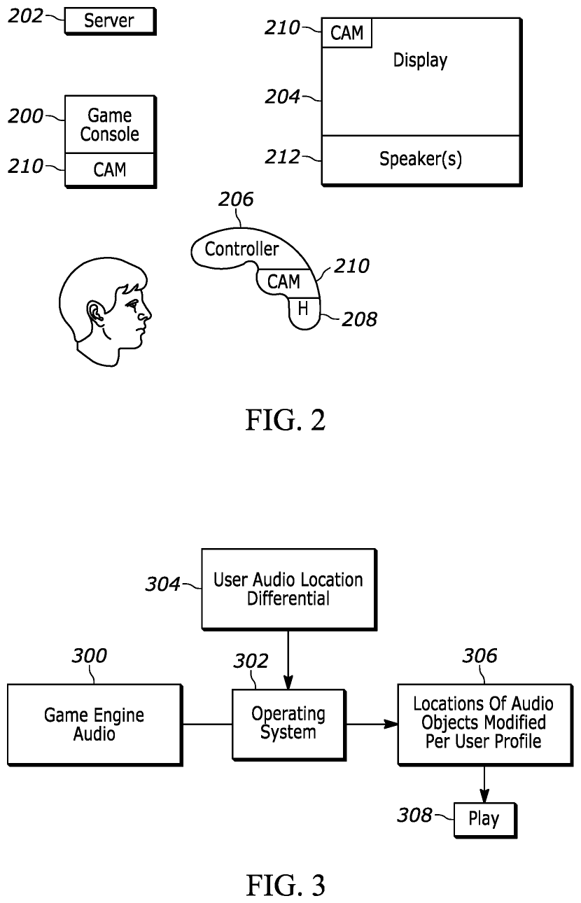

Refer now to FIG. 2. A computer simulation such as a computer game may be sent from a computer game console 200 or a computer game server 202 to a display device 204 such as a TV for presentation of the computer simulation under control of one or more computer simulation controllers 206, such as but not limited to a PlayStation® controller or other controller.

One or more haptic generators 208 may be provided on the controller 206. One or more cameras 210 may be provided on the controller and/or console and/or display device as shown. Audio sourced from the game console 200 or server 202 is played on one or more speakers 212 of a speaker system. The elements of the system shown in FIG. 2 can incorporate some or all of the appropriate devices and components described above in reference to FIG. 1.

Refer now to FIG. 3. Audio signals 300 from a game engine executed by, e.g., the console 200 or server 202 shown in FIG. 2 may be detected by an operating system 302 or other software that can also access the personal audio directionality profiles 304 of one or more players of a computer simulation such as a computer game. As indicated at 306, the O.S. 302 or other software alters or modifies the demanded virtual locations of audio objects in the computer simulation according to the audio directionality profile of the current player for play of the virtual objects at block 308 at the modified virtual locations on the speaker system.

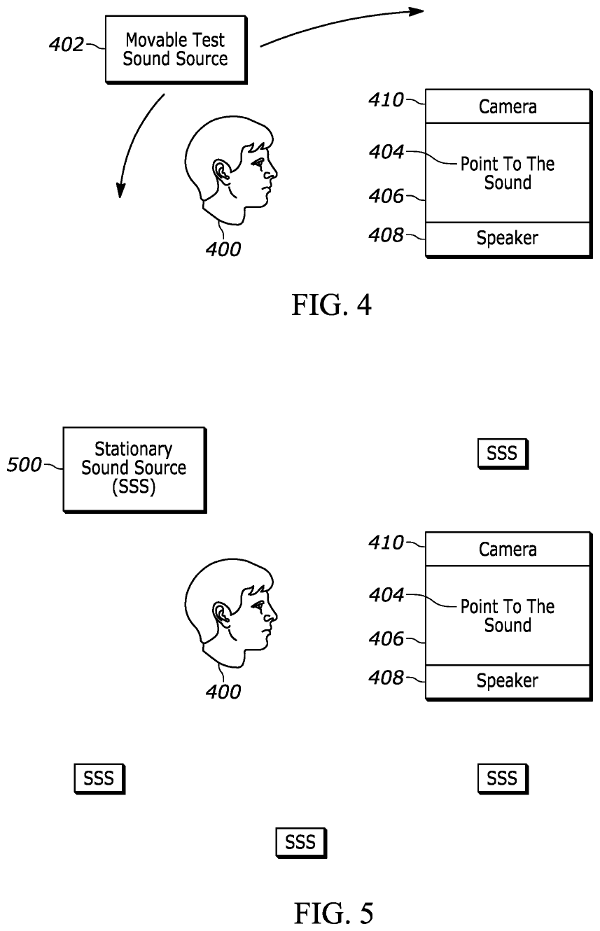

FIG. 4 illustrates a first non-limiting example system for establishing the audio directionality profile of a person 400. As shown, a source 402 of test sounds such as tones or beeps or other sounds can move in both the vertical and horizontal dimensions as indicated by the arrows. The source 402 may stop at a first location in space, emit a test sound, and a prompt 404 may be presented visibly on a display 406 or audibly on a speaker 408 for the person 400 to point in the direction the person perceives the test sound to emanate from. One or more cameras 410 can image the person and determine, from the direction of the person's pointing appendage, a location on an imaginary sphere over whose surface the source 402 moves. The imaginary sphere is centered on the person's head.

This location is compared to the actual location of the source to determine, for that actual location, a deviation in the person's hearing in vector form, with the direction of vector indicating the offset or deviation from the actual location to the person's indicated location and the magnitude of the vector representing the amount of the offset or deviation.

The source 402 may be moved to multiple locations in 3D space on the inside surface of the imaginary sphere, stopping at each location to emit a test sound and having the person's indicated location recorded for each actual location.

Or, FIG. 5 illustrates that instead of a single (or a few) movable sources of test sounds, the person 400 can be surrounded, e.g., in an anechoic chamber, by a number of stationary sources 500 positioned around the inside surface of an imaginary surface at the center of which is the person's head. A first source may emit a test sound, the person prompted to point at the direction the person perceives the sound to emanate from, and the person imaged to determine, for the actual location of the emitting source, the offset or deviation from the actual location to the person's indicated location. Then, each source may individually activate its test sound one at a time, with the person indicating each time the perceived directionality, until all sources have been activated and the person's response recorded to establish the person's audio directionality profile.

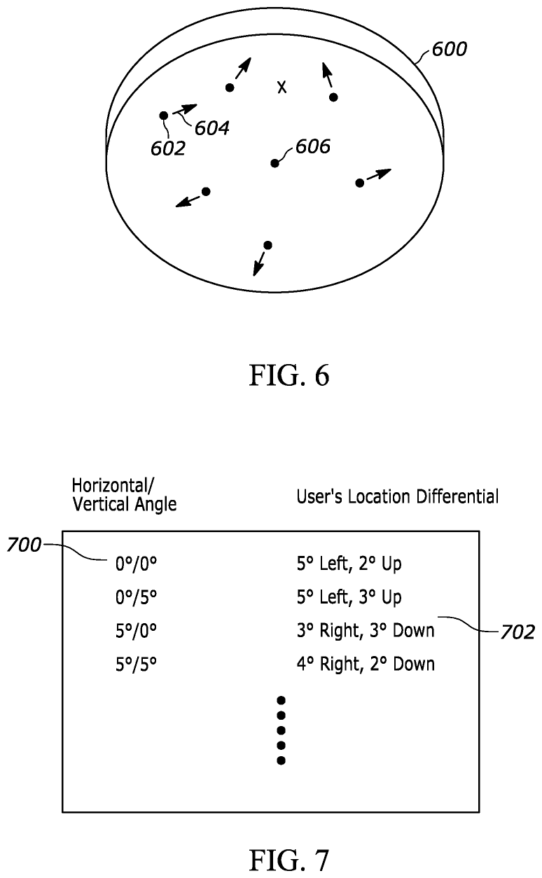

FIG. 6 illustrates the top half of an imaginary sphere 600 with actual locations 602 of test sound emissions and for each location 602, which serves as its origin, a vector 604 representing the direction and magnitude of the offset or deviation in a person's audio directionality profile for that particular location 602. It is to be understood that the bottom half of the sphere 600 is omitted for clarity, and that the sphere 600 is centered at 606 on the head of a person under test. Thus, the person's audio directionality profile is in 3D space in both the horizontal and vertical dimensions. It will readily be appreciated in reference to FIG. 6 that the offset or deviation in a person's audio directionality profile may vary from location 402 to location 402.

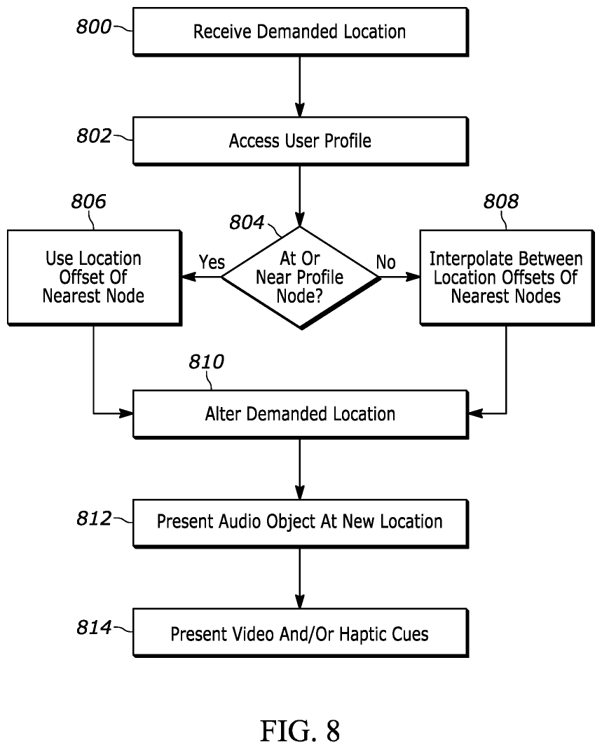

The audio directionality profile shown in FIG. 6 may be stored in graphical form as shown, and/or in tabular form as shown in FIG. 7. More specifically, for each real location of a test source in a first column 700 (indicated by vertical/horizontal degree pairs from the center), a corresponding vector representation is indicated in a second column 702 to indicate the offset or deviation in a person's audio directionality profile for the corresponding real location in the first column 700. As shown, a vector representation in the second column 702 may be an indication of deviation, in degrees, in both the horizontal and vertical dimensions in the person's audio directionality profile from the actual location.

With this understanding in mind, attention is now drawn to FIG. 8 for logic that may be implemented by any processor herein executing software such as the O.S. 302 shown in FIG. 3. Commencing at block 800, a demanded virtual location is received for an audio object in a computer simulation. Moving to block 802, the audio directionality profile for the current player is accessed.

Decision diamond 804 indicates that it is determined whether the demanded virtual location is at (or within some threshold distance of) one of the actual locations in the audio directionality profile to which a corresponding offset or deviation vector has been paired. If so, the logic moves to block 806 to select that offset or deviation.

On the other hand, if the demanded virtual location is not at (or not within some threshold distance of) one of the actual locations in the audio directionality profile to which a corresponding offset or deviation vector has been paired, the logic moves to block 808. At block 808, the two (or more) actual locations in the audio directionality profile that are closest to the demanded virtual location are identified and the directions and magnitudes of the associated offset or deviation vectors are interpolated. Interpolation may be linear and may be relative to the demanded virtual location.

Once an offset or deviation is determined from block 806 or block 808, at block 810 the logic alters the demanded virtual location according to the offset or deviation. As but one example, the demanded virtual location may be moved in a direction and distance opposite to that indicated by the offset or deviation, so that the person, by virtue of the offset or deviation, hears the object as if it were at the original demanded virtual location.

Block 812 indicates that the audio object is presented in the speaker system at the modified virtual location produced at block 810 instead of the original demanded virtual location received at block 800.

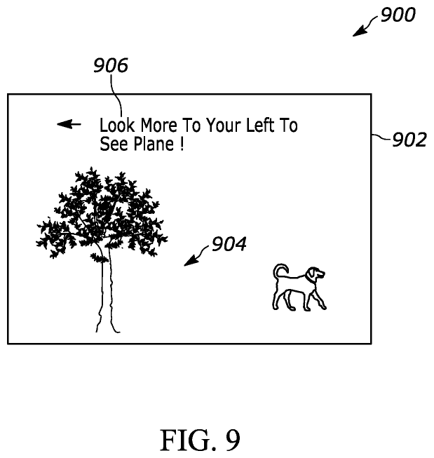

If desired, video and/or haptic cues of the audio object may be presented at block 814 in addition to or in lieu of altering the original demanded virtual location. In this regard, refer now to FIG. 9.

FIG. 9 illustrates a UI 900 that may be presented on a display 902 such as a head-mounted virtual reality (VR) or augmented reality (AR) display that presents a computer simulation 904 (in the example shown, consisting of a tree and an animal). The UI 900 also provides a visual prompt 906 for the player to look toward the location of an audio object that the player might not hear, or hear in the correct direction.

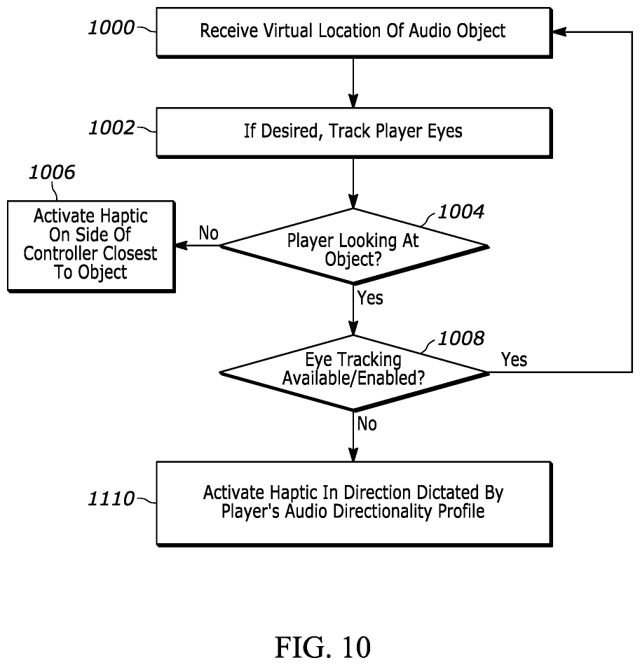

FIG. 10 illustrates logic that uses haptic cues instead of or in addition to visual cues to help a person focus on an audio object. Commencing at block 1000, the demanded virtual location of an audio object is received. In one embodiment the logic flows to block 1002 to track the eyes of the person playing the game, and if it is determined at decision diamond 1004 that the person is not looking at the audio object, the logic may move to block 1006 to activate a haptic generator 208 on the controller 206 shown in FIG. 2 for example that is the closest haptic generator to the side of the controller corresponding to the demanded virtual location of the audio object.

In another embodiment incorporated into FIG. 10, if eye tracking is not available or is disabled at decision diamond 1008, the logic may move to block 1110. At block 1110, the logic may activate a haptic generator 208 on the controller 206 shown in FIG. 2 for example that is in a direction from the center of the controller corresponding to the vector in the player's audio directionality profile that is associated with the demanded virtual location of the audio object.

The person's audio directionality profile also may be used to train the person to better localize sound. For instance, the profile as illustrated in FIG. 6 may be visually presented to the person to give the person an idea of the offsets or deviations in the person's audio directionality for various locations in space.

While the particular embodiments are herein shown and described in detail, it is to be understood that the subject matter which is encompassed by the present invention is limited only by the claims.

What is claimed is:

1. An apparatus comprising:
at least one processor configured to:
identify a directional deviation in hearing of a person;
alter a demanded virtual location of at least one audio object according to the directional deviation to render a modified location; and
present the audio object at the modified location.

2. The apparatus of claim 1, wherein the processor is configured to identify the directional deviation based at least in part on an audio directionality profile of the person in both the horizontal and vertical dimensions.

3. The apparatus of claim 2, wherein the audio directionality profile comprises directional deviations at respective locations.

4. The apparatus of claim 3, wherein a first one of the directional deviations has a different direction than a second one of the directional deviations.

5. The apparatus of claim 3, wherein the respective locations comprise locations in space around the head of the person.

6. The apparatus of claim 1, wherein the directional deviation comprises a vector.

7. The apparatus of claim 1, wherein the directional deviation is a first directional deviation associated with a first location and the processor is configured to:
identify a second directional deviation in hearing of the person, the second directional deviation being associated with a second location, the demanded virtual location being between the first and second locations; and
render the modified location of the audio object at least in part by interpolating between the first and second directional deviations.

8. The apparatus of claim 1, wherein the processor is configured to:
present at least one visual cue of a location of the audio object.

9. The apparatus of claim 1, wherein the processor is configured to:
present at least one tactile cue of a location of the audio object.

10. A method, comprising:
identifying a location for at last one audio object in a computer simulation; and
presenting at least one visual cue of the location, or presenting at least one tactile cue of the location, or both presenting a visual and a tactile cue of the location.

11. The method of claim 10, comprising:
presenting at least one visual cue of the location.

12. The method of claim 10, comprising presenting at least one tactile cue of the location.

13. The method of claim 10, comprising both presenting a visual and a tactile cue of the location.

14. A device comprising:
at least one computer storage that is not a transitory signal and that comprises instructions executable by at least one processor to:
identify a demanded virtual location for an audio object in a computer simulation;
access an audio directionality profile for a player of the computer simulation, the audio directionality profile comprising at last one offset or deviation in hearing directionality; and
alter the demanded virtual location according to the offset or deviation.

15. The device of claim 14, wherein the instructions are executable to play the audio object on at least one speaker after altering the demanded virtual location.

16. The device of claim 14, wherein the instructions are executable to alter the demanded virtual location by presenting the audio object at a virtual location that is in a direction relative to the demanded virtual location opposite to that indicated by the offset or deviation.

17. The device of claim 14, wherein the offset or deviation is a first offset or deviation associated with a first location and the instructions are executable to:
identify a second offset or deviation in hearing of the person, the second offset or deviation being associated with a second location, the demanded virtual location being between the first and second locations; and
alter the demanded virtual location at least in part by interpolating between the first and second offsets or deviations.

18. The device of claim 14, wherein the instructions are executable to:
present at least one visual cue of a location of the audio object.

19. The device of claim 14, wherein the instructions are executable to:
present at least one tactile cue of a location of the audio object.

20. The device of claim 14, comprising the at least one processor.
